(19) United States
(12) Patent Application Publication
(10) Pub. No.: US 2026/0160006 A1
(43) Pub. Date: Jun. 11, 2026

(54) SEWING HEAD

(71) Applicant: Inteva Products, LLC, Troy, MI (US)

(72) Inventor: Edward J. Wenzel, Troy, MI (US)

(21) Appl. No.: 19/183,391

(22) Filed: Apr. 18, 2025

Related U.S. Application Data
(60) Provisional application No. 63/636,521, filed on Apr. 19, 2024.

(51) Int. Cl. D05B 3/02; B25J 11/00; D05B 19/14

(52) U.S. Cl. CPC D05B 3/025; B25J 11/005; D05B 19/14

(57) ABSTRACT

A composite sewing head, including: a needle bar transport for a thread feed needle and a thread catcher needle that is arranged to be parallel to a needle plane of the thread feed needle and a thread catcher needle, with the needle plane parallel or nearly parallel to a stitch path.

### CROSS REFERENCE TO RELATED APPLICATIONS

This application claims the benefit of U.S. Provisional Application No. 63/636,521 filed on Apr. 19, 2024 the entire contents of which are incorporated herein by reference thereto.

### TECHNICAL FIELD

Exemplary embodiments of the present disclosure pertains to the art of sewing heads and/or robotic sewing heads for use in sewing processes.

### BACKGROUND

Sewing production may involve a robotic sewing cell. Robotic sewing technology may use a sewing head. As the types of materials being sewn together changes improvements are needed to existing sewing heads in order to perform the desired stitching process.

As such, it is desirable to provide an improved robotic sewing head and method of use.

### BRIEF DESCRIPTION

Disclosed is a composite sewing head.

Also disclosed is a composite sewing head with a needle and sleeve.

Disclosed is a composite sewing head, including: a needle bar transport for a thread feed needle and a thread catcher needle that is arranged to be parallel to a needle plane of the thread feed needle and a thread catcher needle, with the needle plane parallel or nearly parallel to a stitch path.

In addition to one or more of the features described above, or as an alternative to any of the foregoing embodiments, an angle between the catcher needle and the feed needle is adjustable.

In addition to one or more of the features described above, or as an alternative to any of the foregoing embodiments, the catcher needle further comprises a sleeve to prevent a hook of the catcher needle from engaging with laminate fibers upon retraction the catcher needle from a laminate containing the laminate fibers.

In addition to one or more of the features described above, or as an alternative to any of the foregoing embodiments, the catcher needle further comprises a sleeve to prevent a hook of the catcher needle from engaging with laminate fibers upon retraction the catcher needle from a laminate containing the laminate fibers.

Also disclosed is a sewing assembly, including: a composite sewing head, the composite sewing head including: a needle bar transport for a thread feed needle and a thread catcher needle that is arranged to be parallel to a needle plane of the thread feed needle and a thread catcher needle, with the needle plane parallel or nearly parallel to a stitch path; a fixture for supporting a composite to be sewn by the composite sewing head, the fixture having a channel located in a surface of the fixture, the channel having a width configured to accept movement of the thread feed needle and a thread catcher needle as they pass through the composite; and a robot secured to the composite sewing head for manipulating a location of the composite sewing head with respect to the fixture as the composite is being sewn by the composite sewing head.

In addition to one or more of the features described above, or as an alternative to any of the foregoing embodiments, an angle between the catcher needle and the feed needle is adjustable.

In addition to one or more of the features described above, or as an alternative to any of the foregoing embodiments, the catcher needle further comprises a sleeve to prevent a hook of the catcher needle from engaging with laminate fibers of the composite upon retraction the catcher needle from composite containing the laminate fibers.

In addition to one or more of the features described above, or as an alternative to any of the foregoing embodiments, the catcher needle further comprises a sleeve to prevent a hook of the catcher needle from engaging with laminate fibers of the composite upon retraction the catcher needle from composite containing the laminate fibers.

In addition to one or more of the features described above, or as an alternative to any of the foregoing embodiments, the sewing assembly further includes a sensor for detecting a thickness of the composite.

In addition to one or more of the features described above, or as an alternative to any of the foregoing embodiments, the sensor is located at a defined distance ahead of but preferably inline with the needle plane.

In addition to one or more of the features described above, or as an alternative to any of the foregoing embodiments, the sensor is an ultrasonic sensor.

In addition to one or more of the features described above, or as an alternative to any of the foregoing embodiments, the sensor provides feedback to a sewing head controller for controlling a location of the composite sewing head with respect to the composite.

In addition to one or more of the features described above, or as an alternative to any of the foregoing embodiments, an angle between the catcher needle and the feed needle is adjustable.

Also disclosed is a method for sewing a composite material, including: sewing the composite material with a composite sewing head, wherein a needle bar transport for a thread feed needle and a thread catcher needle of the composite sewing head that is arranged to be parallel to a needle plane of the thread feed needle and a thread catcher needle, with the needle plane parallel or nearly parallel with a stitch path.

In addition to one or more of the features described above, or as an alternative to any of the foregoing embodiments, the composite sewing head is secured to a robot for manipulating a location of the composite sewing head with respect to a fixture for supporting a composite to be sewn by the composite sewing head, the fixture having a channel located in a surface of the fixture, the channel having a width configured accept movement of the thread feed needle and a thread catcher needle as they pass through the composite.

In addition to one or more of the features described above, or as an alternative to any of the foregoing embodiments, an angle between the catcher needle and the feed needle is adjustable.

In addition to one or more of the features described above, or as an alternative to any of the foregoing embodiments, the catcher needle further comprises a sleeve to prevent a hook of the catcher needle from engaging with laminate fibers of the composite upon retraction the catcher needle from composite containing the laminate fibers.

In addition to one or more of the features described above, or as an alternative to any of the foregoing embodiments, the method includes detecting a thickness of the composite with a sensor operably coupled to a sewing head controller for controlling a location of the composite sewing head with respect to the composite.

In addition to one or more of the features described above, or as an alternative to any of the foregoing embodiments, the sensor is located at a defined distance ahead of and inline with the needle plane.

In addition to one or more of the features described above, or as an alternative to any of the foregoing embodiments, the sensor is an ultrasonic sensor.

### BRIEF DESCRIPTION OF THE DRAWINGS

The following descriptions should not be considered limiting in any way. With reference to the accompanying drawings, like elements are numbered alike:

FIG. 1 illustrates a conventional machine feed;

FIG. 2 illustrates a sideslip machine feed;

FIG. 3 illustrates a machine feed and sewing head in accordance with the present disclosure;

FIG. 3A illustrates a machine feed and sewing head in accordance with the present disclosure;

FIG. 4 is perspective view of a portion of a composite sewing head in accordance with the present disclosure;

FIG. 5 is a view of a catcher needle and sleeve in accordance with the present disclosure;

FIG. 6 is a view of a catcher needle in accordance with the present disclosure;

FIG. 7 is a view of a sleeve for a catcher needle in accordance with the present disclosure;

FIG. 8 is a view of a sewing cell in accordance with the present disclosure; and

FIG. 9 is a top view of a sewing fixture in accordance with the present disclosure.

### DETAILED DESCRIPTION

A detailed description of one or more embodiments of the disclosed apparatus and method are presented herein by way of exemplification and not limitation with reference to the Figures.

### Overview

The present disclosure is directed to a single-sided sewing head for the purpose of stitching together layers of a dry non-crimped carbon fiber multiaxial laminate to enhance z-axis (through thickness) strength as well as enhance the resistance to delamination of composite laminates

The sewing head is also used to attached stringers, frame stacks, stringer and frame straps, tapes and other reinforcements to the skin of a composite structure.

The sewing head can be mounted to a robot to enable the head to be articulated over the surface of a 3D composite structure.

### Current State-of-the-Art

A single sided sewing head using two needles and a single thread.

The thread is fed through composite laminate using a needle angled 45 degrees (feed needle) to the composite laminate surface.

While the thread feed needle is fully extended through the composite laminate, the thread from the feed needle is hooked by a second needle (catcher needle) that penetrates the composite laminate 90 degrees to the A-surface or show surface of the composite laminate.

The catcher needle then carries the thread through the composite laminate. Once pulled completely through, a thread picker engages and retains the thread, allowing the catcher needle to move downward through the loop for the next cycle before releasing the thread loop.

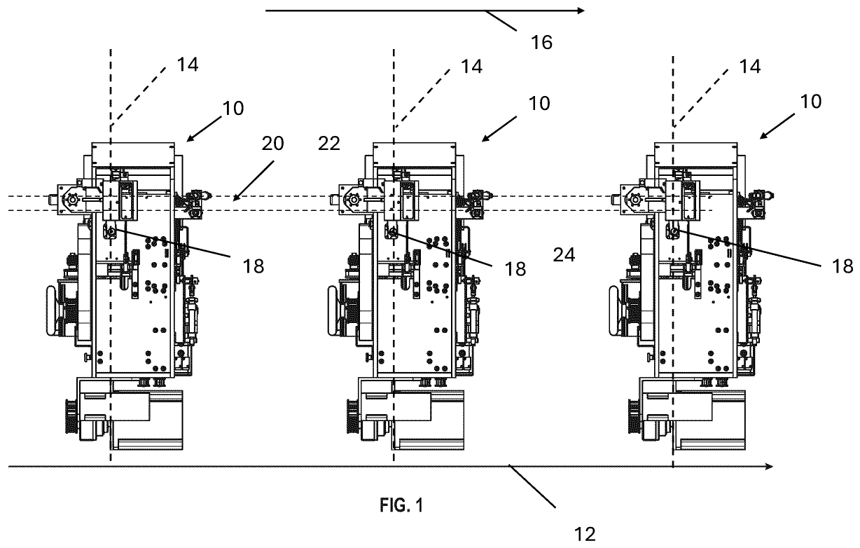

Referring now to FIG. 1 movement of a sewing head 10 in the direction of arrow 12 is illustrated. In FIG. 1, the movement of the sewing head 10 in the direction of arrow 12 is illustrated by the three images of the sewing head 10. The direction of arrow 12 may be referred to as the sewing head path. Here the needle plane of sewing head 10 is illustrated by the dashed lines 14. In this configuration, the needle plane 14 is arranged at a 90 degree angle with respect to the sewing head path 12 or stitch direction illustrated by arrow 16. The sewing head 10 has a thread feed needle and a thread catcher needle contained within the needle plane that is arranged 90 degrees with respect to the stitch path. Movement of the needle plane containing the thread feed needle and the thread catcher needle is facilitated by a needle bar transport 18 arranged to move the needle plane parallel to the stitch path.

The configuration of the thread feed needle and the thread catcher needle require a channel 20 defined by dashed lines 22 and 24. The passage or channel 20 is located in a fixture that supports a composite laminate that is being stitched by the sewing head 10. The channel 20 needs to be wide enough to provide clearance for the sewing needle(s) (the thread feed needle and the thread catcher needle) upon penetration through the backside of the composite laminate. The large width of the channel that is cut into the fixture along the sewing path can allow the laminate material to be pushed into the channel during sewing, which is undesirable. Current methods used to prevent material displacement into the fixture channel 20 consist of adding a veil of material between the B-side of the composite laminate and the top side of the sewing fixture to provide support to the laminate. The time required to install the veil between each part sewing cycle is excessive and leads to a significant increase in the overall processing time to produce a finished composite product. As such, the width of the channel 20 illustrated in FIG. 1 is too wide.

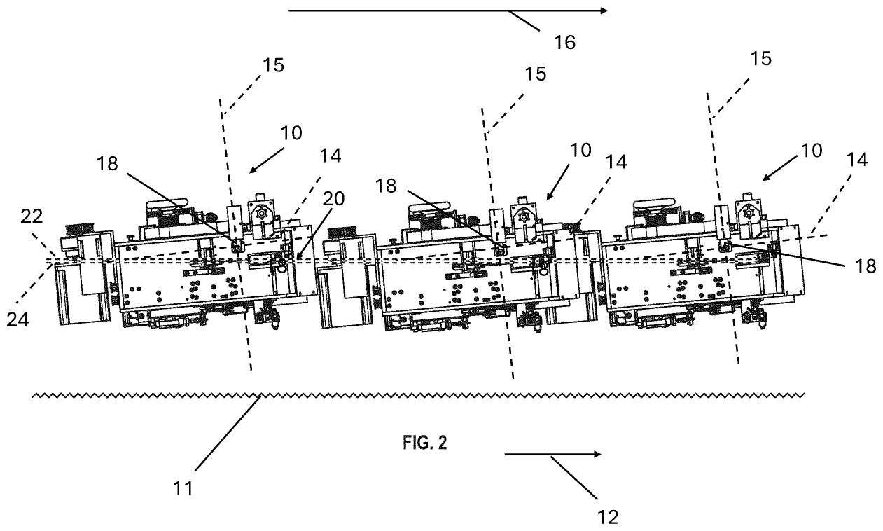

Referring now to FIG. 2, a sewing head 10 of a sideslip machine is illustrated. Again movement of the sewing head 10 in the direction of the sewing head path 12 is illustrated. In FIG. 2, the movement of the sewing head 10 in the direction of arrow 12 is illustrated by the three images of the sewing head 10. The direction of arrow 12 may be referred to as the sewing head path. Here the needle plane of sewing head 10 illustrated by the dashed lines 14 is offset from the sewing head path 12 or stitch direction illustrated by arrow 16 by about 5 degrees. However and in this configuration, the needle bar transport 18 is arranged approximately 85 degrees with respect to the stitch path 16. See dashed lines 15.

The sewing head 10 illustrated in FIG. 2 has a thread feed needle and a thread catcher needle that are arranged about 85 degrees with respect to the stitch path. Movement of the thread feed needle and the thread catcher needle are facilitated by a needle bar transport 18 approximately 85 degrees with respect to the stitch path 16.

The configuration of the thread feed needle and the thread catcher needle of the head 10 of FIG. 2 requires a channel 20 defined by dashed lines 22 and 24. While this channel 20 is smaller than the channel 20 of FIG. 1, the robot must move the sewing head in a zig zag pattern as illustrated by line 11 in FIG. 2 to ensure that the robot path movement is parallel to the needle plane transport direction. As such, the sew path programming is complex and the sewing speed is slow as compared to what is desired.

Limitations with Current State-of-the-Art (FIGS. 1 and 2)

There is a lack of power to drive the sewing needle(s), thread feed needle and the thread catcher needle through the composite.

Breakage of sewing needles.

The catcher needle hook tends to catch on the composite laminate as it is being withdrawn from the laminate. Damage to the composite laminate fibers can lead to reduced performance under load as well as stitching irregularities.

The thread picker can fray the thread during removal from the catcher needle.

It is also difficult to achieve consistent thread tension across stitching path.

As mentioned above, the passage or channel 20 required along the sewing path 16 in a fixture that supports the composite laminate needs to be wide enough to provide clearance for the sewing needle(s) (the thread feed needle and the thread catcher needle) upon penetration through the backside of the composite laminate. The large width of the channel that is cut into the fixture along the sewing path can allow the laminate material to be pushed into the channel during sewing. Current methods used to prevent material displacement into the fixture channel consist of adding a veil of material between the B-side of the composite laminate and the top side of the sewing fixture to provide support to the laminate. The time required to install the veil between each part sewing cycle is excessive and leads to a significant increase in the overall processing time to produce a finished composite product.

### Improvements to Current State-of-the-Art

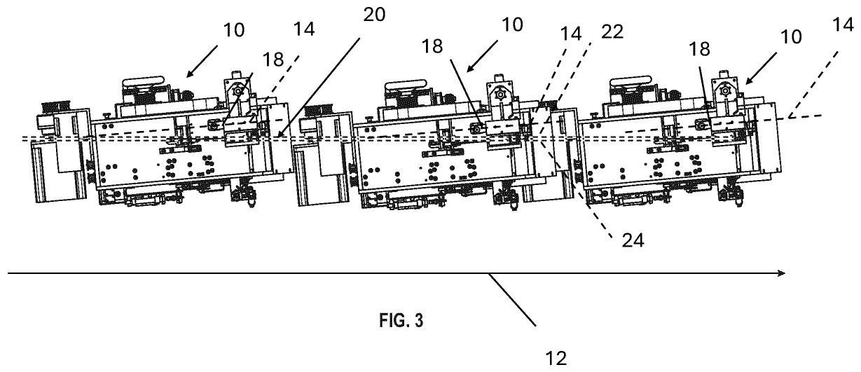

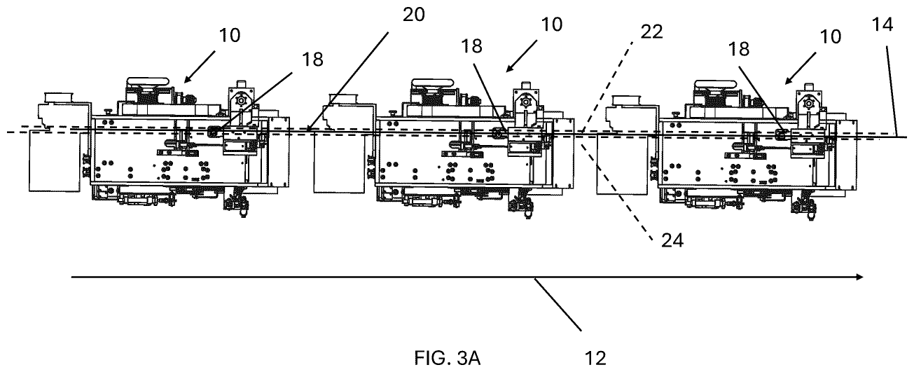

Referring now to at least FIGS. 3, 3A, a sewing head or composite sewing head and method of the present disclosure is illustrated. Here the needle bar transport is parallel to the needle plane instead of perpendicular (e.g., 90 degrees) to the needle plane as illustrated in FIGS. 1 and 2. With the needle bar transport arranged parallel to the needle plane, and the needle plane parallel or nearly parallel (5 to 15 degrees) to the stitch path, the width of the of needle projection through the B-side of the laminate stack is reduced and thus the width of the channel 20 on the laminate support fixture can be reduced. As such the width of the channel 20 that needs to be machined into a top side surface of the laminate support fixture is minimized. This will also enable increased sewing speed.

As used herein “needle bar transport” refers to a mechanism in the sewing head 10 for facilitating reciprocal movement of at least the thread feed needle and the thread catcher needle in order to stitch a thread through a part surface.

In addition and in another embodiment of the present disclosure, the catcher needle is encapsulated by a sleeve during penetration through the composite laminate. The sleeve will cover the hook portion of the catcher needle during needle passage through the laminate and prevent the hook from engaging with the laminate fibers upon needle retraction. The sleeve is movably secured to the catcher needle to allow for a thread picker to engage and retain the thread during operation but cover the hook portion of the catcher needle during needle passage through the laminate and prevent the hook from engaging with the laminate fibers upon needle retraction.

The angle between the catcher and feed needles is adjustable so that the sewing head 10 can be setup to manage a variety of composite material thicknesses and compositions.

The sewing head 10 can also provide real time compensation for variations in the material thickness during sewing. This is provided by an ultrasonic sensor or other types of sensors or sensor means for detecting composite laminate thickness and will be placed at a defined distance ahead of the needle bar plane. This sensor will detect variation in laminate thickness and provide feedback to the sewing head controller in real time. Prior to the sewing head reaching the point of thickness variation, the position of the pressor foot position and sewing head normal to the laminate surface will be adjusted automatically to ensure a consistent depth of needle penetration along the entire stitch path. Maintaining a consistent depth of needle penetration beneath the B-side of the laminate will ensure that no stitching irregularity occurs.

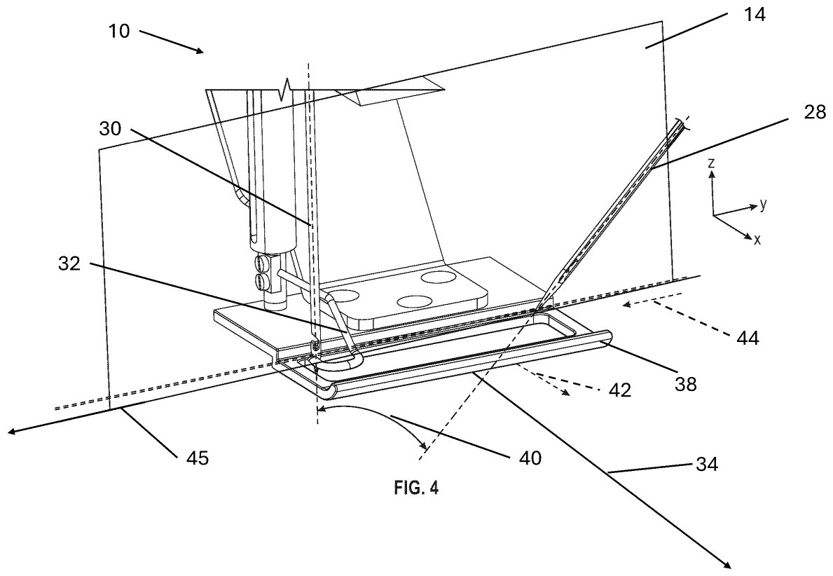

Referring now to FIG. 4, portions of the sewing head 10 is illustrated. Also, illustrated is the needle plane 14. Also illustrated is a thread feed needle 28, a thread catcher needle 30, a thread picker 32, an existing stitch path 34, an existing needle bar transport direction 42, a presser foot 38, an angle 40 between the thread feed needle 28 and the thread catcher needle 30, a proposed needle bar transport direction illustrated by arrow 44, a proposed stitch path illustrated by arrow 45.

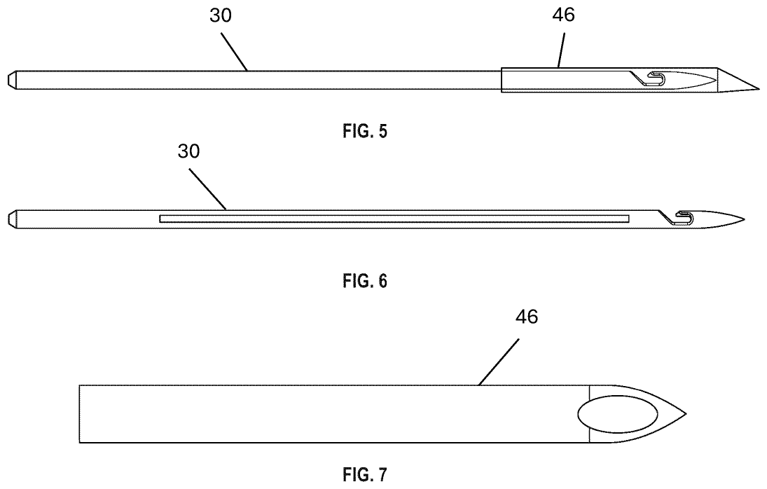

Referring now to at least FIGS. 5-7, a catcher needle 30 and a sleeve 46 for the catcher needle 30 is illustrated. FIG. 5 illustrates the catcher needle 30 and sleeve 46 while FIG. 6 illustrates the catcher needle 30 and FIG. 7 illustrated the needle sleeve 46. In one non-limiting embodiment, one non-limiting outer diameter of the catcher needle 30 is approximately 2.38 mm and one corresponding non-limiting outer diameter of the needle sleeve 46 is approximately 2.9 mm. It is, of course, understood that in accordance with the present disclosure the outer diameter of the catcher needle 30 and the outer diameter of the needle sleeve 46 may be greater or less than the aforementioned dimensions of 2.38 mm and 2.9 mm.

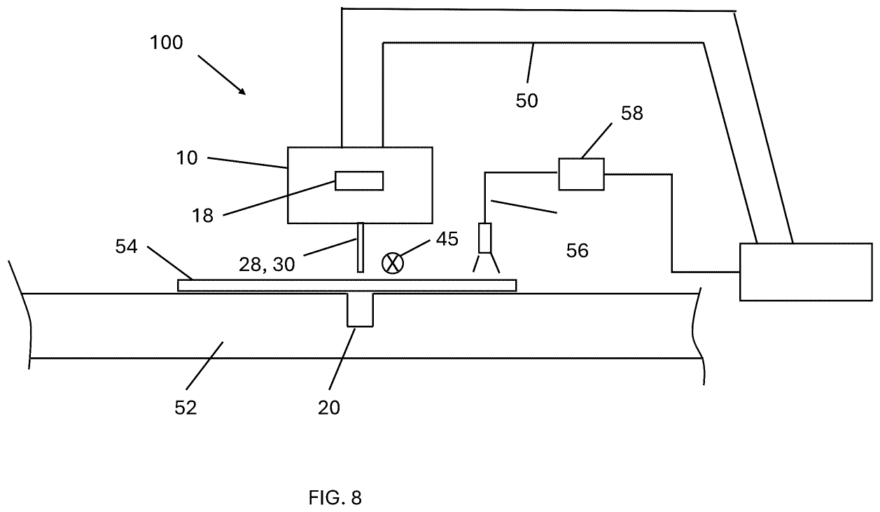

Referring now to at least FIG. 8, a sewing assembly 100 is illustrated in accordance with the present disclosure. The sewing assembly 100 includes the sewing head 10 which is secured to a robot 50. The stitch path 45 is normal to the plane of FIG. 8. The needle bar transport 18 is illustrated schematically by box 18 and the thread feed needle 28 and the thread catcher needle 30 are illustrated by the box labeled 28, 30. Also shown is a fixture 52 with the aforementioned channel 20. A composite laminate or laminates 54 for being sewn together are also shown. Also shown is a sensor 56 that may be secured to the sewing head 10 for detecting a thickness of the composite laminate 54 that is places at a defined distance ahead and inline with the needle bar plane. This sensor 56 will detect variations in the laminate 54 thickness and provide feedback to a sewing head controller 58 in real time. As such, and prior to the sewing head 10 reaching the point of thickness variation, both the position of the pressor foot 38 normal to the laminate 54 surface and the sewing head 10 will be adjusted automatically to ensure a consistent depth of needle penetration along the entire stitch path. Maintaining a consistent depth of needle penetration beneath the B-side of the laminate will ensure that no stitching irregularity occurs.

In an embodiment, the controller 58 may include memory to store instructions that are executed by one or more processors. The executable instructions may be stored or organized in any manner and at any level of abstraction, such as in connection with a controlling and/or monitoring operation of the robot 50 and the sewing head 10. The one or more processors can be any type of central processing unit (CPU), including a general purpose processor, a digital signal processor (DSP), a microcontroller, an application specific integrated circuit (ASIC), a field programmable gate array (FPGA), or the like. Also, in embodiments, the memory may include random access memory (RAM), read only memory (ROM), or other electronic, optical, magnetic, or any other computer readable medium onto which is stored data and control algorithms in a non-transitory form.

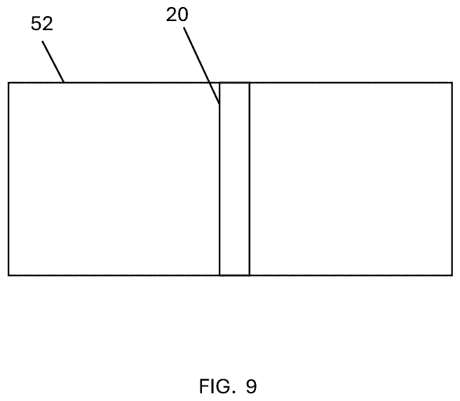

FIG. 9 is a top plan view of a fixture 52 with a channel 20.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A composite sewing head, comprising:
a needle bar transport for a thread feed needle and a thread catcher needle that is arranged to be parallel to a needle plane of the thread feed needle and a thread catcher needle, with the needle plane parallel or nearly parallel to a stitch path.

2. The composite sewing head as in claim 1, wherein an angle between the catcher needle and the feed needle is adjustable.

3. The composite sewing head as in claim 2, wherein the catcher needle further comprises a sleeve to prevent a hook of the catcher needle from engaging with laminate fibers upon retraction the catcher needle from a laminate containing the laminate fibers.

4. The composite sewing head as in claim 1, wherein the catcher needle further comprises a sleeve to prevent a hook of the catcher needle from engaging with laminate fibers upon retraction the catcher needle from a laminate containing the laminate fibers.

5. A sewing assembly, comprising:
a composite sewing head, the composite sewing head including: a needle bar transport for a thread feed needle and a thread catcher needle that is arranged to be parallel to a needle plane of the thread feed needle and a thread catcher needle, with the needle plane parallel or nearly parallel to a stitch path;
a fixture for supporting a composite to be sewn by the composite sewing head, the fixture having a channel located in a surface of the fixture, the channel having a width configured to accept movement of the thread feed needle and a thread catcher needle as they pass through the composite; and
a robot secured to the composite sewing head for manipulating a location of the composite sewing head with respect to the fixture as the composite is being sewn by the composite sewing head.

6. The sewing assembly as in claim 5, wherein an angle between the catcher needle and the feed needle is adjustable.

7. The sewing assembly as in claim 6, wherein the catcher needle further comprises a sleeve to prevent a hook of the catcher needle from engaging with laminate fibers of the composite upon retraction the catcher needle from composite containing the laminate fibers.

8. The sewing assembly as in claim 5, wherein the catcher needle further comprises a sleeve to prevent a hook of the catcher needle from engaging with laminate fibers of the composite upon retraction the catcher needle from composite containing the laminate fibers.

9. The sewing assembly as in claim 5, further comprising a sensor for detecting a thickness of the composite.

10. The sewing assembly as in claim 9, wherein the sensor is located at a defined distance ahead of but preferably inline with the needle plane.

11. The sewing assembly as in claim 10, wherein the sensor is an ultrasonic sensor.

12. The sewing assembly as in claim 9, wherein the sensor provides feedback to a sewing head controller for controlling a location of the composite sewing head with respect to the composite.

13. The sewing assembly as in claim 9, wherein an angle between the catcher needle and the feed needle is adjustable.

14. A method for sewing a composite material, comprising:
sewing the composite material with a composite sewing head, wherein a needle bar transport for a thread feed needle and a thread catcher needle of the composite sewing head that is arranged to be parallel to a needle plane of the thread feed needle and a thread catcher needle, with the needle plane parallel or nearly parallel with a stitch path.

15. The method as in claim 14, wherein the composite sewing head is secured to a robot for manipulating a location of the composite sewing head with respect to a fixture for supporting a composite to be sewn by the composite sewing head, the fixture having a channel located in a surface of the fixture, the channel having a width configured accept movement of the thread feed needle and a thread catcher needle as they pass through the composite.

16. The method as in claim 14, wherein an angle between the catcher needle and the feed needle is adjustable.

17. The method as in claim 15, wherein the catcher needle further comprises a sleeve to prevent a hook of the catcher needle from engaging with laminate fibers of the composite upon retraction the catcher needle from composite containing the laminate fibers.

18. The method as in claim 15, further comprising:
detecting a thickness of the composite with a sensor operably coupled to a sewing head controller for controlling a location of the composite sewing head with respect to the composite.

19. The method as in claim 18, wherein the sensor is located at a defined distance ahead of and inline with the needle plane.

20. The method as in claim 18, wherein the sensor is an ultrasonic sensor.
